(19) United States
(12) Patent Application Publication
(10) Pub. No.: US 2022/0079335 A1
(43) Pub. Date: Mar. 17, 2022

(54) ADJUSTABLE UNDERGROUND CONDUIT STUB-UP RACK

(71) Applicant: Electrical Specialists Inc. DBA The Superior Group, Columbus, OH (US)

(72) Inventors: John Alexander, Alexandria, OH (US); Joel L. Poupart, New Holland, OH (US)

(21) Appl. No.: 17/474,009

(22) Filed: Sep. 13, 2021

Related U.S. Application Data
(60) Provisional application No. 63/077,686, filed on Sep. 13, 2020.

(51) Int. Cl. A47B 45/00; A47B 96/14; H02G 3/22

(52) U.S. Cl. CPC A47B 45/00; H02G 3/22; A47B 96/1466

(57) ABSTRACT

An adjustable conduit stub-up rack is provided, the rack comprising: structural members and sliding members, wherein at least some of the structural members are frame structural members and form a rectangular frame, wherein at least some of the structural members are vertical support structural members and at least some of the structural members are horizontal support structural members, wherein the support structural members slide relative to one another via the sliding members, and wherein the vertical structural members slide along the horizontal structural members.

### CROSS-REFERENCE TO RELATED APPLICATIONS

This application claims priority from U.S. Provisional Patent Application No. 63/077,686, filed on Sep. 13, 2020, which is incorporated by reference herein in its entirety.

### BACKGROUND

During the construction of structures, it is common to run electrical wires through conduit to meet with electrical codes, protect the wires, protect individuals who may contact the wires, and/or to maintain an orderly and clean appearance.

One common scenario in which wires are run through conduit involves wires being passed through a concrete slab that has yet to be poured. In such a scenario, conduit may be laid in or on the ground upon which the concrete slab is to be poured and may be “stubbed up” through the area where the concrete pad is to be poured, typically through a 90 degree bend from a generally horizontal direction to a generally vertical direction. This stubbed-up conduit must be secured in position before and during the pouring of the concrete slab so as to ensure that the stubbed-up conduit is in the proper position after the pouring of the slab, with the desired spacing where more than one conduit is stubbed-up (for example, stubbed-up conduit may be intended for alignment and engagement with pre-punched holes in equipment or electrical boxes, and in this or similar situations, accurate spacing and orientation is important). The securing of the stubbed-up conduit must be such that the conduit does not deflect, bend, or otherwise yield to the heavy concrete that is to be poured on and around it.

What is needed is a device for maintaining the position, orientation, and spacing of conduit stubbed up through a concrete slab.

### SUMMARY

In one aspect, an adjustable conduit stub-up rack is provided, the rack comprising: structural members and sliding members, wherein at least some of the structural members form a rectangular frame, wherein at least some of the structural members are vertical structural members and at least some of the structural members are horizontal structural members, wherein the structural members slide relative to one another via the sliding members, and wherein the vertical structural members slide along the horizontal structural members.

In another aspect, an adjustable conduit stub-up rack is provided, the rack comprising: structural members and sliding members, wherein at least some of the structural members are frame structural members and form a rectangular frame, wherein at least some of the structural members are vertical support structural members and at least some of the structural members are horizontal support structural members, wherein the structural members slide relative to one another via the sliding members, and wherein the vertical structural members slide along the horizontal structural members.

### BRIEF DESCRIPTION OF THE DRAWINGS

The accompanying figures, which are incorporated in and constitute a part of the specification, illustrate various example systems and apparatuses, and are used merely to illustrate various example embodiments. In the figures, like elements bear like reference numerals.

FIG. 1 illustrates a perspective view of an adjustable underground conduit stub-up rack 100.

FIG. 2A illustrates a perspective view of a portion of an adjustable underground conduit stub-up rack 200 including structural members 206 and sliding members 204.

FIG. 2B illustrates a perspective view of a different portion of adjustable underground conduit stub-up rack 200 including structural members 206 and sliding members 204.

FIG. 2C illustrates a perspective view of a different portion of adjustable underground conduit stub-up rack 200 including structural members 206 and sliding members 204.

FIG. 3 illustrates a perspective view of an adjustable underground conduit stub-up rack 300.

### DETAILED DESCRIPTION

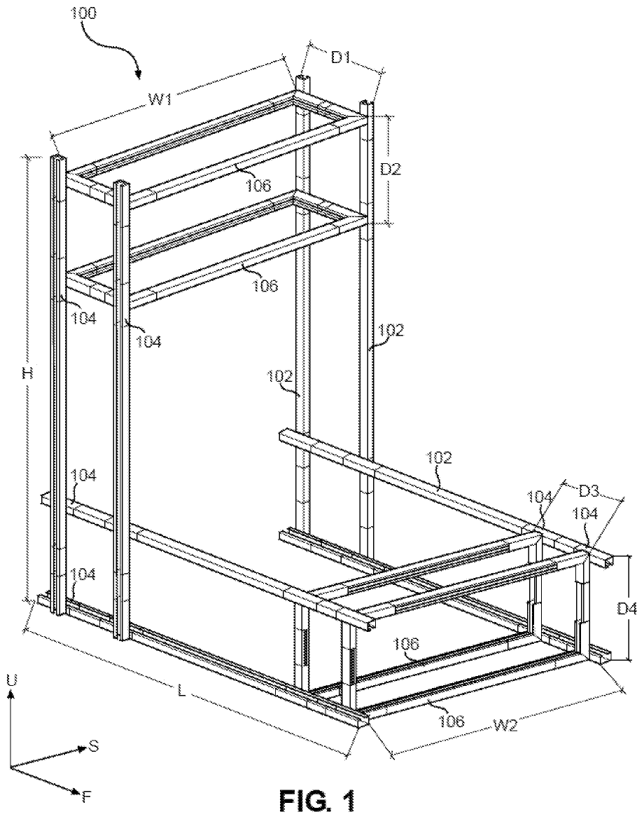

FIG. 1 illustrates an adjustable underground conduit stub-up rack 100. Rack 100 includes structural members 102, 106, and sliding members 104. Frame structural members 106 may form a rectangular frame, and via sliding members 104 may slide up and down, and forward and backward, on support structural members 102. Further, vertical support structural members 102 may slide forward and backward along horizontal support structural members 102 via sliding members 104. In this manner, rack 100 is adjustable in size through the use of sliding members 104.

As illustrated in FIG. 1, up U, forward F, and laterally or sideways S are defined as indicated. Rack 100 is adjustable in size, including for example the height H of frame structural members 106, the length L of frame structural members 106, the widths W1, W2 of vertical support structural members 102, and the depths D1, D2, D3, and D4 of frame structural members 106.

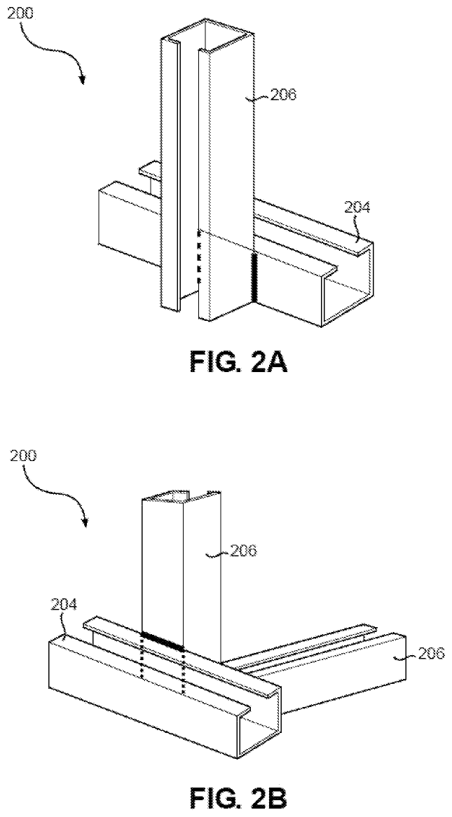

Frame structural members 106 form conduit-holding frames, through which conduit may extend. Support structural members 102 may act to support frame structural members 106. Sliding members 104 may be dimensioned to fit around structural members 102, 106, as further described and illustrated in FIGS. 2A-2C, and thus slide along structural members 102, 106.

FIGS. 2A-2C illustrate a portion of an adjustable underground conduit stub-up rack 200 including frame structural members 206 and sliding members 204. Sliding members 204 may include inside dimensions that permit sliding members 204 to slide along the outside of frame structural members 106 and/or support structural members 102. That is, frame structural members 106 and/or support structural members 102 may fit within and telescope within sliding members 104 illustrated in FIG. 1.

Sliding members 204 may be fastened to structural members 206 via any of a variety of fastening techniques, including for example, via welding.

Once rack 100 is oriented in the desired size, shape, and orientation, sliding members 104, 204 may be fixed in position relative to frame structural members 106 and/or support structural members 102 via one or more fastener (e.g., a bolt, screw, or rivet), an adhesive, a weld, or the like.

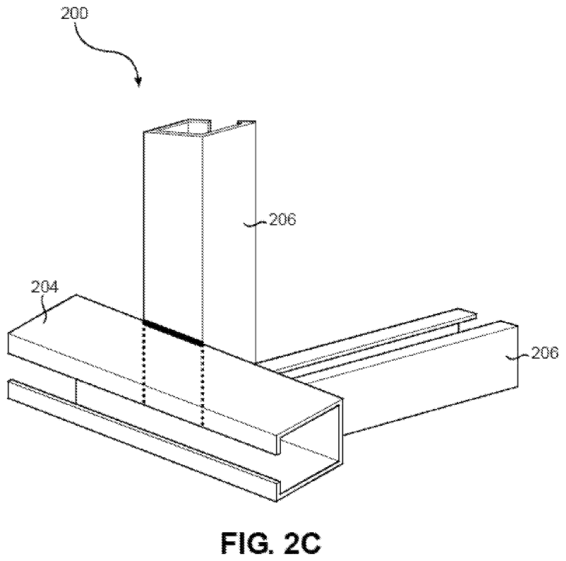

FIG. 3 illustrates an adjustable underground conduit stub-up rack 300. Rack 300 includes structural members 302, 306, and sliding members 304. Frame structural members 306 may form a rectangular frame, and via sliding members 304 may slide up and down, and forward and backward, on support structural members 302. Conduit 310 may extend through the frame formed by frame structural members 306. Further, vertical support structural members 302 may slide forward and backward along horizontal support structural members 302 via sliding members 304. In this manner, rack 300 is adjustable in size through the use of sliding members 304.

At least one conduit 310 may be fixed within rack 300. A conduit 310 bend may be fixed within rack 300. Conduit 310 may extend through and be at least partially fixed within the frame formed by frame structural members 306.

Sliding members 304 may be telescoping strut (e.g., Unistrut, slotted strut, or the like), sized and arranged to slide along the outer periphery of structural members 302, 306.

Frame structural members 306 may include ductbank plates oriented within the rectangular frame formed by frame structural members 306, the ductbank plates including a plurality of conduit apertures configured to maintain the orientation, position, and spacing of conduit 310.

The adjustability of racks 100, 200, 300 permits the racks to be used with various sizes and dimensions of conduit 310, and in various sizes and dimensions of conduit 310 stub-ups.

The adjustability of racks 100, 200, 300 may permit the racks to be easily disassembled and shipped in such a disassembled state to minimize the space necessary for shipping.

Any of structural members 102, 106, 302, 306 may be formed from a square tubing, rectangular tubing, building strut (e.g., Unistrut, slotted strut, or the like), angle iron, or the like, and may be formed from any of a variety of materials, including for example a metal (e.g., steel), an alloy, a polymer, an organic material, a composite, or the like. Any of sliding members 104, 204, 304 may be formed from a square tubing, rectangular tubing, building strut (e.g., Unistrut, slotted strut, or the like), angle iron, or the like, and may be formed from any of a variety of materials, including for example a metal (e.g., steel), an alloy, a polymer, an organic material, a composite, or the like. Sliding members 104, 204, 304 may be hollow and/or have a shape and size configured to fit over, around, or against structural members 102, 106, 302, 306.

The racks 100, 200, 300 may include upper and lower frame members, the upper frame members being nearer the vertical portion of the bent conduit, and the lower frame members being nearer the horizontal portion of the bent conduit. The racks 100, 200, 300 may include a pair of upper frame members and a pair of lower frame members, the pair of upper frame members being nearer the vertical portion of the bent conduit, and the pair of lower frame members being nearer the horizontal portion of the bent conduit. The conduit 310 may extend through each of the pair of frame members.

In one embodiment, an adjustable conduit stub-up rack is provided, the rack comprising: structural members and sliding members, wherein at least some of the structural members form a rectangular frame, wherein at least some of the structural members are vertical structural members and at least some of the structural members are horizontal structural members, wherein the structural members slide relative to one another via the sliding members, and wherein the vertical structural members slide along the horizontal structural members.

The adjustable conduit stub-up rack, wherein the structural members forming the rectangular frame are frame structural members.

The adjustable conduit stub-up rack, wherein the vertical structural members and the horizontal structural members are support structural members.

The adjustable conduit stub-up rack, wherein the frame structural members fit within the sliding members, and wherein the sliding members slide along an outside of the frame structural members.

The adjustable conduit stub-up rack, wherein the support structural members fit within the sliding members, and wherein the sliding members slide along an outside of the support structural members.

The adjustable conduit stub-up rack, wherein the sliding members are fastened to structural members via welding.

The adjustable conduit stub-up rack, wherein at least one conduit extends through the rectangular frame.

The adjustable conduit stub-up rack, wherein the structural members are building struts.

The adjustable conduit stub-up rack, wherein the sliding members are building struts.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include±10% of the number. In other words, “about 10” may mean from 9 to 11.

As stated above, while the present application has been illustrated by the description of alternative aspects thereof, and while the aspects have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. An adjustable conduit stub-up rack, comprising:
structural members and sliding members,
wherein at least some of the structural members form a rectangular frame,
wherein at least some of the structural members are vertical structural members and at least some of the structural members are horizontal structural members,
wherein the structural members slide relative to one another via the sliding members, and
wherein the vertical structural members slide along the horizontal structural members.

2. The adjustable conduit stub-up rack of claim 1, wherein the structural members forming the rectangular frame are frame structural members.

3. The adjustable conduit stub-up rack of claim 1, wherein the vertical structural members and the horizontal structural members are support structural members.

4. The adjustable conduit stub-up rack of claim 2, wherein the frame structural members fit within the sliding members, and wherein the sliding members slide along an outside of the frame structural members.

5. The adjustable conduit stub-up rack of claim 3, wherein the support structural members fit within the sliding members, and wherein the sliding members slide along an outside of the support structural members.

6. The adjustable conduit stub-up rack of claim 1, wherein the sliding members are fastened to structural members via welding.

7. The adjustable conduit stub-up rack of claim 1, wherein at least one conduit extends through the rectangular frame.

8. The adjustable conduit stub-up rack of claim 1, wherein the structural members are building struts.

9. The adjustable conduit stub-up rack of claim 1, wherein the sliding members are building struts.

10. An adjustable conduit stub-up rack, comprising:
structural members and sliding members,
wherein at least some of the structural members are frame structural members and form a rectangular frame,
wherein at least some of the structural members are vertical support structural members and at least some of the structural members are horizontal support structural members,
wherein the structural members slide relative to one another via the sliding members, and
wherein the vertical structural members slide along the horizontal structural members.

11. The adjustable conduit stub-up rack of claim 10, wherein the frame structural members fit within the sliding members, and wherein the sliding members slide along an outside of the frame structural members.

12. The adjustable conduit stub-up rack of claim 10, wherein the support structural members fit within the sliding members, and wherein the sliding members slide along an outside of the support structural members.

13. The adjustable conduit stub-up rack of claim 10, wherein the sliding members are fastened to structural members via welding.

14. The adjustable conduit stub-up rack of claim 10, wherein at least one conduit extends through the rectangular frame.

15. The adjustable conduit stub-up rack of claim 10, wherein the structural members are building struts.

16. The adjustable conduit stub-up rack of claim 10, wherein the sliding members are building struts.
